(19) United States
(12) Patent Application Publication
(10) Pub. No.: US 2004/0103061 A1
(43) Pub. Date: May 27, 2004

(54) Smart card for accelerated payment of medical insurance

(76) Inventors: Richard Glee Wood, Houston, TX (US); Wesley Jack White, JR., Spring, TX (US)

Correspondence Address: Wendy K. Buskop, Buskop Law Group, P.C., Suite 500, 1717 St. James Place, Houston, TX, 77056, US

(21) Appl. No.: 10/303,217

(22) Filed: Nov. 25, 2002

(51) Int. Cl. G06F 17/60; G06K 9/00; G06F 17/00

(52) U.S. Cl. 705/41; 705/4; 705/2; 382/124; 235/375

(57) ABSTRACT

The invention is a smart card used to accelerate the provision of funds to a service provider for medical insurance, wherein the smart card has a card substrate and a microchip embedded in the card substrate, wherein the microchip contains information on the insured, insurer, and other related information in order to communicate information concerning the insured, insurer, and other related information between parties involved in the medical transaction to facilitate the process for providing funds for medical services rendered.

### FIELD OF THE INVENTION

The present invention relates to a card, known as a smart card, whose purpose is to facilitate the process for providing funds, as an advance against proposed charges, by containing identification, security measures, and other information in order to eliminate fraud on insurance companies.

### BACKGROUND OF THE INVENTION

Physicians have traditionally had to wait long periods of time to get paid for their medical services. Physicians, physical therapists and others have been required to extend credit to individuals with insurance in order to get paid. This situation has become tedious and caused health care costs to be very high.

Pharmacists have had the use of automated services, such as the TelePAID system. The TelePAID system offered by PAID prescriptions LLC is a system that uses a plastic card that contains only a group number. A pharmacist, in turn, manually enters the group number, member number, and prescription information, in an attempt to give the card holder the lowest customer price in the system. The pharmacist then provides the customer with the prescription and collects the approved amount from the TelePAID system. The customer is given a receipt including an authorization number. This system has the insured paying for the balance. A need has long existed for a system, wherein the insurer advances funds so that the insured does not have to handle money.

This need has been particularly great for incapacitated individuals, such as those in nursing homes, who are no longer able to handle funds or complicated transactions.

The cost of health care continues to increase as the health care industry becomes more complex, specialized, and sophisticated. The proportion of the gross domestic product that is accounted for by health care is expected to gradually increase over the coming years as the population ages and new medical procedures become available.

Over the years, the delivery of health care services is not only from individual physicians but also from large managed health maintenance organizations, hospitals, pharmacists, and mental health therapists. There are growing numbers of medical, dental, and pharmaceutical specialists in a complex variety of health care options and programs to service the increasing populations, which has increased in elderly populations.

Unfortunately, the payment for the delivered health care is now occurring much later than the delivery of the service. Increasingly, health care providers are acting as credit institutions for the insured because of the lack of insurers to timely provide funds under a policy.

The cost of supporting patient costs has increased during recent years, thereby contributing to today's costly health care system. A significant portion of the increase in the cost of medical service is caused by the administrative costs represented by the systems for creating, reviewing and adjudicating health care provider payment requests. Such payment requests typically include bills for procedures performed and supplies given to patients. Currently, the systems for reviewing and adjudicating payment requests represent additional health care transaction costs that directly reduce the efficiency of the health care system and increases the cost of the health care delivered.

A need exists to reduce the magnitude of transaction costs involved in reviewing and adjudicating payment requests that would have the effect of reducing the rate of increase of health care costs.

A need exists for streamlining payment request review and adjudication that would also positively increase the portion of the health care dollar that is spent on treatment rather than administration.

A need exists to reduce the traditionally high cost of health care administration, including the review and adjudication of payment requests which results from health care service providers having to act as “banks” or “credit sources” for patients.

A need exists to facilitate the understanding of the contractual obligations between the service provider and the insured. Often, there are many different contractual arrangements between different patients, insurers, and health care providers. The amount of authorized payment may vary by the service or procedure, by the particular contractual arrangement with each health care provider, by the contractual arrangements between the insurer and the patient regarding the allocation of payment for treatment, and by what is considered consistent with current medical practice.

During recent years, the process of creating, reviewing, and adjudicating payment requests from health care providers has become increasingly automated. For example, there exist claims processing systems whereby technicians at health care providers' offices electronically create and submit medical insurance claims to a central processing system. The technicians include information identifying the physician, patient, medical service, insurer, and other data with the medical insurance claim. The central processing system verifies that the physician, patient, and insurer are participants in the claims processing systems. If so, the central processing system converts the medical insurance claim into the appropriate format of the specified insurer, and the claim is then forwarded to the insurer. Upon adjudication and approval of the insurance claims, the insurer initiates a check to the provider. In effect, such systems bypass the use of the mail for delivery of insurance claims. However, there is no known system for accelerated payment of funds within only a day or two of the claims presentation.

In partially automated systems, such as that described in the foregoing example, the technician can submit a claim via electronic mail on the Internet or by other electronic means. To do so, the technician establishes communication with an Internet service provider or another wide area network. While communication is maintained, the technician sends the insurance claim to a recipient and then either discontinues communication or performs other activities while communication is established. Using such conventional systems, personnel at the health care provider's office are unable to determine whether the submitted claim is in condition for payment and do not receive any indication, while communication is maintained, whether the claim will be paid.

Because of the large number of insurers and insurance plans, the amount of the co-payment can vary from patient to patient and from visit to visit. Moreover, when a patient is not covered for a certain treatment, the patient may be liable for the entire amount of the health care services. It is sometimes difficult for technicians at the office of the health care provider to determine that amount of any co-payment or any other amount due from the patient, such as a deductible that must be collected while the patient remains at the office after a medical visit. Once the patient leaves the office, the expense of collecting amounts owed by patient increases and the likelihood of being paid decreases. Conventional insurance claim submission systems have not been capable of efficiently and immediately informing technicians at the offices of a health care provider of amounts owed by patients, particularly when the amount is not a fixed dollar amount. A need has been desired, particularly by patients (insured) and health care providers for a solution to this dilemma.

Other methods and apparatus exist to attempt to streamline the insurance claim payment process, such as the method disclosed in Gamble U.S. Pat. No. 6,163,770. This patent reveals using a digital electrical apparatus to generate output for insurance documentation for a first insurance policy having a first risk and claims while revealing a concurrent second insurance policy for a second risk, wherein the second risk is different from the first. The processor of this method is connected to a memory device for storing and retrieving operations including machine-readable signals in the memory device, to an input device for receiving input data and converting the input data into input electrical data, to a visual display unit for converting output electrical data into output having a visual presentation, to a printer for converting the output electrical data into printed documentation, wherein the processor is programmed to control the apparatus to receive the input data and to produce the output data by steps including: inputting actuarial assumptions defining the first insurance policy; and computing a value of a specific financial attribute of the first insurance policy. The method further includes the step of inserting the value of the financial attribute in the first insurance policy and other printed documentation related to the first insurance policy.

In view of the foregoing, there is a need for a more fully automated claim processing system that have the ability to have an accelerated pay schedule and an ability to reduce the uncertainty as to whether a claim to be submitted is likely to be paid or rejected.

Further, security is an issue of paramount importance in electronic communication. The card containing many elements of personal and private information must be secure from all types of intrusion by unwarranted attempts to access. Only the owner of the card can give permission to read the card and establish the communication links to the owner's private files at the insurer or any other location where information may reside. This activity must be incompliance with all applicable privacy laws and the card and its security must have the ability to change along with laws should a change occur. The card will help facilitate that compliance. Again, the need for security is paramount.

The present invention has been developed to provide a smart card to accelerate claims processing system that would more easily allow health care providers to know what patient and treatment information must accompany insurance claims, whether or not a patient is eligible for accelerated fee payment, and to obtain funds quickly against rendered services from insurance companies. The present invention also includes various elements to provide security for the user.

### SUMMARY OF THE INVENTION

The invention overcomes the prior art by providing a smart card for accelerating the provision of funds to a service provider for medical insurance. The smart card is a card substrate and a microchip embedded in said card substrate. The microchip contains information on the insured and insures, as well as secondary information necessary to the medical service. The smart card aids in facilitating the transfer of information between the insured, the service provider, and the insurer.

### BRIEF DESCRIPTION OF THE DRAWINGS

The present invention will be explained in greater detail with reference to the appended Figures, in which:

FIG. 1 is a front view of a smart card;

FIG. 2 is a back view of the smart card;

FIG. 3 is a diagrammatic representation of the information contained on the smart card usable in the invention;

FIG. 4 is a diagrammatic representation of the service provider information stored in the smart card;

FIG. 5a is diagrammatic representation of the co-insurance information stored in the smart card; and

FIG. 6 is diagrammatic representation of the transmission codes stored in the smart card.

The present invention is detailed below with reference to the listed Figures.

### DETAILED DESCRIPTION OF THE PREFERRED EMBODIMENTS

Before explaining the present invention in detail, it is to be understood that the invention is not limited to the particular embodiments and that it can be practiced or carried out in various ways.

The invention is a smart card for accelerating the provision of funds to a service provider for medical insurance.

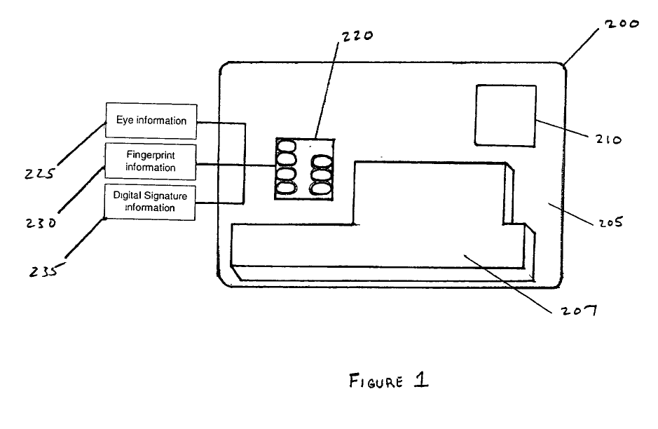

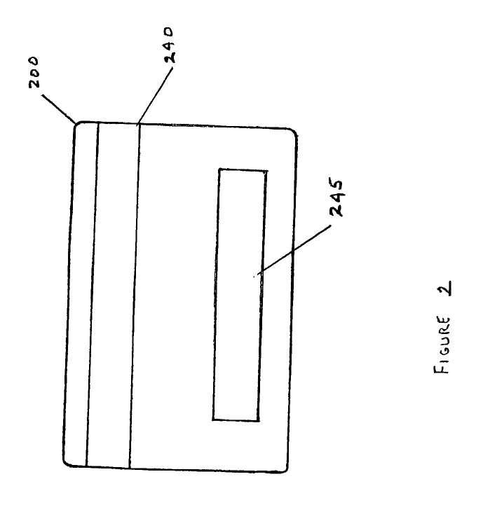

FIG. 1 shows a front view of the smart card (200), while FIG. 2 shows the back view of the smart card (200). Physically, the smart card (200) includes a card substrate and a microchip (220) embedded in the card substrate. As seen in FIG. 1, the smart card also has a picture (210) of the user along with design markings (207) identifying the card as a smart card (200), the name of the user and other common identifiers. These design markings (207) can be the mark of insurer, the mark of the service provider, and the mark of any third party. Examples of third parties includes an insurance middle middleman, a pharmacy, a medical equipment provider, a financial institution, a grocery store, a manager of a medical plan, a car rental agency, an airline, a office supply chain, a hotel chain, recreational company marks and combinations thereof.

As seen in FIG. 2, the back of the smart card (200) has a magnetic medium (240) and a place for the user to sign his name (245) so any signature can be verified.

The smart card (200) includes numerous security devices to protect the user. FIG. 1 shows that the microchip (220) can include eye information (225), fingerprint information (230), and digital signature information (235). Electronic fingerprinting and fingerprint recognition is a currently believed secure method of identification. This is far more secure than PIN codes that can be obtained even when encrypted relatively easily. Social security numbers are generally not considered secure. It is necessary for the individual who owns the smart card to have unique identifiers to allow access to the information on the card. Using first a fingerprint encoding device, the fingerprint or fingerprints of the owner of the card are loaded onto the non re-writable portion of the card's chip. A fingerprint reader connected to the card reader matches the real time image of the fingerprint(s) to the stored image and then provides electronic verification that the card and its owner are together at the same time. The owner can then enter a PIN code or other security code that will allow access to the information on the card by the then approved reader. The owner's authorization allows information to be shared between approved parties.

In the same way the fingerprint devices and stored images can be used for matching, other verification and authorization recognition devices can be used as well. Laser or optical retinal scanning and facial recognition scanning use the same techniques with different equipment. First, the image of the retina of the owner's eye is scanned and recorded permanently onto the chip of the card in a non-changeable location and format. At the time of verification a scanner is used to scan the card owner's retina in real time and compare the recorded image to the real time one. If there is a match then the owner's identity is verified and they can proceed to provide other authorizations as above.

Facial recognition works in the same manner as retinal scanning as does several other forms of “optical” recognition and verification. The smart card (200) is contemplated to have all of these security measures.

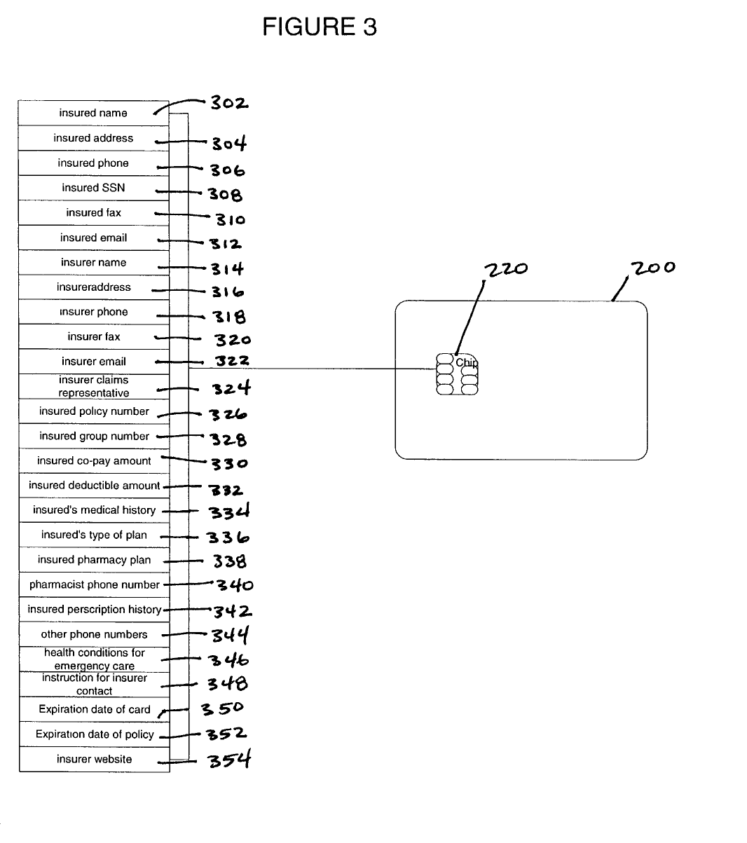

The microchip (220) also has information about the insurer and insured. FIG. 3 is representation of the information included on the microchip (220). The microchip (220) includes information pertaining directly to the insured. This insured information is the name (302), address (304), phone number (306), social security number (308), fax number (310), and e-mail address (312). The microchip (220) also has information about the insurer like the insurer name (314), insurer address (316), insurer phone number (318), insurer fax number (320), insurer e-mail address (322), the insurer claims representative (324), and insurer website (354).

The microchip (220) also includes information that assists in accelerating the provision of funds to a service provider for medical insurance, as shown in FIG. 3. The microchip (220) has the insured policy number (326); the insured group number (328); insured's co-pay amount (330); insured deductible amount (332); insured's medical history (334); and the insured type of plan (336). The microchip also contains secondary information such as the insured pharmacy plan (338); pharmacist phone number (340); insured prescription history (342); and emergency care health conditions (346). The microchip (220) also includes other phone numbers (344), instructions on how to contact insurer (348), expiration date of card (350), and expiration date of policy (352), and any other combinations of the included information.

The microchip (220) can also have medical information, like medicinal prescriptions, for executing the medical transaction.

The smart card (200) functions to communicate various types of information between insurer, insured, and other parties concerned in accelerating the provision of funds to a service provider for medical insurance. The functions of the smart card (200) include:

i. communicating one or more of the information items encoded on the microchip (220) and shown in FIG. 3;

ii. verifying the insured is the owner of the smart card;

iii. communicating the insured's identification information to the insurer;

iv. communicating the insured's symptoms to the insurer;

v. communicating the service provider information to the insurer;

vi. communicating transmission codes;

vii. communicating insurance coverage is current to the service provider;

viii. communicating claim codes for an insured;

ix. communicating deductible and co-payments required of insured;

x. communicating co-insurance information;

xi. communicating insured's medical history to enable a service provider to evaluate a proposed treatment;

xii. communicating the proposed treatment to an insurer;

xiii. communicating the cost to be charged from the proposed treatment;

xiv. communicating from the insurer that the cost of proposed treatment fit within the guidelines of the insurer;

xv. communicating authorization codes to perform the proposed treatment;

xvi. communicating notice from the service provider that additional service for the insured may be needed;

xvii. communicating eligibility of a service provider for accelerated funds transfer;

xviii. communicating that the proposed treatment to the insured has been provided to the insurer;

xix. communicating the deductible and co-payments were made by the insured to the service provider to the insurer;

xx. communicating annual and ever-to-date insurers report to the insured;

xxi. communicating complete medical history to the insured;

xxii. communicating the status of payment to the service provider for the proposed treatment; and

xxiii. communicating combinations thereof.

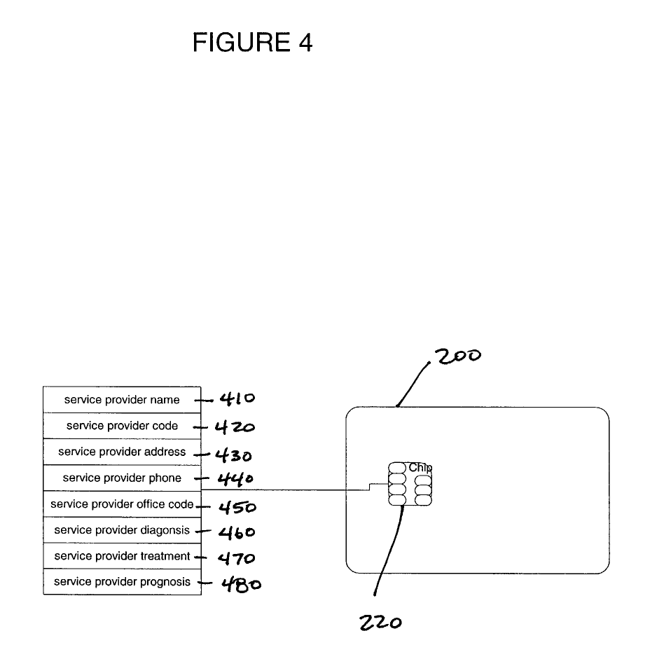

As listed above, one of the functions of the smart card (200) is to communicate the service provider information to the insurer. FIG. 4 shows the service provider information stored in the smart card (200). The information found on the microchip (220) includes service provider name (410); service provider code (420); service provider address (430); service provider phone number (440); service provider office code (450); service provider's diagnosis (460); service provider's treatment (470); and service provider's prognosis (480).

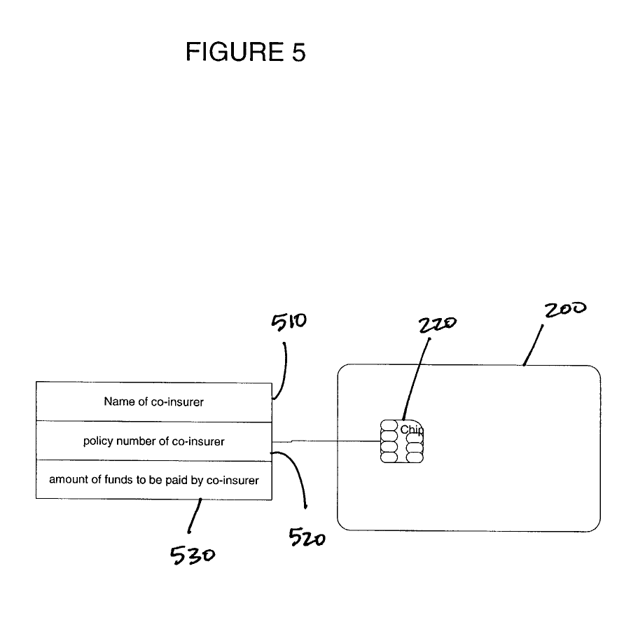

Another function of the smart card (200), as listed above, includes communicating co-insurance information. FIG. 5 is a diagrammatic representation of the co-insurance information stored in the microchip (220) on the smart card (200). The insurance information is the name of co-insurer (510), the policy number of co-insurer (520), the amount of funds to be paid by co-insurer (530), and combinations thereof.

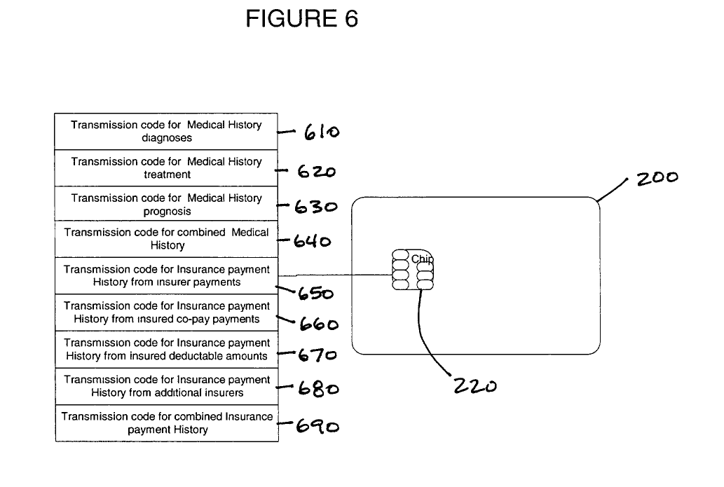

FIG. 6 shows the transmission codes stored in the smart card (200). The transmission codes are also located on the microchip (220). The transmission codes are for medical history diagnosis (610), treatment (620), prognosis (630), and combinations of a medical history (640). Other transmission codes are for insurance payment histories. These codes are for histories from insurer payments (650), from insurer co-pay payments (660), from insured deductible amounts (670), from additional insurers (680), and for combined insurance payment histories (690).

The smart card (200) itself can further have a magnetic medium (240) on the card substrate. Both the microchip (220) and the magnetic medium (240) can contain all or a portion of the information.

In an alternative embodiment, the smart card (200) is a magnetic readable card for accelerating the provision of funds to a service provider for medical insurance with a card substrate and a magnetic medium on the card substrate.

In the preferred embodiment, the smart card (200) is used to facilitate methods concerning accelerating the provision of funds to a service provider from medical insurance using a smart card. This means, the method relates to the provision of money, such as $75 for an office visit, to a general practice physician from medical insurance, such as a United Health Care Select Plus POS™ using a plastic card with a chip in it containing information on the insured. It is also contemplated that a plastic smart card could be used with a magnetic strip without a chip.

The invention advantageously reduces fraud on insurance companies by eliminating physician or service provider's inadvertent creation of non-patients, people who do not exist, and eliminates non-service lodes for billing service that were not rendered. Advantageous the invention permits a comparison of the list of doctors, patients, and the insurer's records for easy audit. Also dates of service approved could be compared to services performed dates to audit record and reduce fraud.

First, a user must obtain medical insurance coverage from an insurer for a person. Typical medical insurance coverage can be government medical insurance coverage, such as a United States medical insurance, known as Medicare or Medicaid, or it can be state government insurance, such as a Texas Employer's Insurance, or even private medical insurance coverage, such as Guardian medical insurance or United Health Care Insurance. Typically, a person completes an application for insurance through their employer or individually and submits the information to the insurance company. A policy is then issued to the person for the insurance coverage. The policy can be an individual policy or a group policy.

A smart card (200) is created for the insured. For the chip version of the smart card, the card is first manufactured in a conventional manner, and then the relevant information is downloaded from the computers of the insurance company to the card. For a non-chip version of a smart card, the card manufacturer would provide information about the insured from the insurance company and the relevant information would be embedded in the magnetic strip and then transferred the magnetic strip on the card.

The insured can be the primary insured, a spouse, a non-married “significant partner”, at least one dependent, such as one or more children, or it can be combinations of these.

It is also contemplated to be within the scope of the invention that the primary insured can be an animal, such as a thoroughbred horse, like Secretariat the winning race horse, a famous breeding bull or some other type of registered pure-bred animal, such as an American Kennel Club (AKC) registered animal. The primary insured, if an animal, can be linked with an appropriate animal insurance policy, such as those available through the AKC.

The smart card can contain information about medical insurance coverage for the insured (person or animal) and a personal identification code, such as a personal identification number or “PIN”.

Alternatively, electronic claims submission information through WebMD or THIN that have a payer identification number can be embedded in the card.

It should be noted that some plans have many choices of plans. For example, the Klein plan has choices including Heath Administration Services Med-watch Program for hospital confinements, HHPO (a Health Administration Services Select Hospital Network), an Immediate Care Prescription Program, and a Mail Order Pharmacy Program. All this information can be embedded on the smart card. Alternatively, other codes can be embedded in the card, such as other prescription codes, including the basic insurance number (BIN) number.

Additionally, the smart card can include complete or partial information on the insured's medical history, such as, but not limited to, information on health allergies, like allergies to penicillin, and health problems, such as diabetes, high blood pressure, or very low blood pressure. The card can include “health alerts”, such as those concerning the taking a blood thinner, or any prescription medications that a doctor or emergency room person should particularly be aware of. Additionally, information concerning whether or not the insured has allergies to two or more prescription drugs can be contained in the card.

The smart card can also contain information on funds that are available from an insurer for a completed authorized medical service for a particular patient. For example, the card can contain information on the “accelerated fund payment schedule” or the typical payment schedule for a particular medical service if the two differ. Generally, the phrase “completed authorized medical service” is considered to be a service that has been authorized by contract by the insurer or is a stated item of coverage in an insurance policy, such as “all dental cleanings are priced at $35”.

The accelerated fund payment schedule could be a 100% payment schedule or a partial accelerated fund payment schedule depending on the contract with the insurer. It is contemplated that the funds would move electronically from the insurer's bank account to the service provider's bank account, such as by wire transfer or similar normal electronic banking procedures.

Additionally, the smart card can contain information about the various insurance coverages held by the insured. An insured person can have insurance that could cover dental coverage, medical coverage, mental health, prescription drugs, nursing care, emergency room procedures, and the like.

The smart card can also be used to determine if a medical service is preauthorized by the insurer for the person, such as for a “John Doe”, who is preauthorized for all chest x-rays without need for additional authorization from the insurer.

The smart card can be used to determine if a service provider is preauthorized by the insurer to perform a medical service. For example, the smart card can contain information on all of the blood work related to sugar testing pre-approved by the insurer.

The smart card is used to not only contain the information described above, but to link to the insurer's database and the service provider's database and the service provider's bank account. The smart card facilitates a first transmission from the service provider to the insurer. This first transmission can include information on:

i. determination that the card is valid and the person is eligible;

ii. determination that the service provider is authorized to provide the service;

iii. proposed medical service costs;

iv. information on the medical services; and

v. an acknowledgement that at least one medical service has been rendered from the service provider to the person.

The smart card facilitates the receipt of a second transmission from the insurer to the service provider. This second transmission can contain information on the amount of payment required by the person based on the insurance coverage. The amount of payment can be all or part of a co-payment fee, all or part of a deductible fee and combinations of these fees.

The smart card facilitates a third transmission to the insurer from the service provider. This third transmission includes an acknowledgement that the amount of the co-payment and the deductible has been paid by the person to the service provider thereby initiating payment by the insurer.

It should be noted that in the context of this invention, the insurer is considered an entity that has been authorized by the federal government or a state board of insurance to deliver insurance benefits for medical care.

Additionally, the insurer, as a set in the process, must make contracts with various service providers, such as pharmacists, nurses, doctors, nursing homes that can be linked to the smart card.

While this invention has been described with emphasis on the preferred embodiments, it should be understood that within the scope of the appended claims the invention might be practiced other than as specifically described herein.

What is claimed is:

1. A smart card for accelerating the provision of funds to a service provider for medical insurance, wherein said smart card comprises:
a. a card substrate;
b. a microchip embedded in said card substrate; and
c. wherein the microchip comprises information selected from the group:
i. insured name;
ii. insured address;
iii. insured phone;
iv. insured social security number
v. insured fax;
vi. insured email;
vii. insurer name;
viii. insurer address;
ix. insurer phone;
x. insurer fax,
xi. insurer e-mail;
xii. insurer claims representative;
xiii. insured policy number;
xiv. insured group number;
xv. insured's co-pay amount;
xvi. insured deductible amount;
xvii. insured's medical history;
xviii. insured type of plan;
xix. insured pharmacy plan;
xx. pharmacist phone number;
xxi. prescriptions of insured;
xxii. emergency care health conditions;
xxiii. other phone numbers;
xxiv. instructions on how to contact insurer;
xxv. expiration date of card;
xxvi. expiration date of policy;
xxvii. insurer website;
xxviii. combinations thereof;
d. wherein the smart card functions to communicate information concerning, selected from the group:
i. one or more of the items listed above;
ii. verifying the insured is the owner of the smart card;
iii. communicating the insured's identification information to the insurer;
iv. communicating the insured's symptoms to the insurer;
v. communicating the service provider information to the insurer;
vi. communicating transmission codes;
vii. communicating insurance coverage is current to the service provider;
viii. communicating claim codes for an insured;
ix. communicating deductible and co-payments required of insured;
x. communicating co-insurance information;
xi. communicating insured's medical history to enable a service provider to evaluate a proposed treatment;
xii. communicating the proposed treatment to an insurer;
xiii. communicating the cost to be charged from the proposed treatment;
xiv. communicating from the insurer that the cost of proposed treatment fit within the guidelines of the insurer;
xv. communicating authorization codes to perform the proposed treatment;
xvi. communicating notice from the service provider than additional service for the insured may be needed;
xvii. communicating eligibility of a service provider for accelerated funds transfer;
xviii. communicating that the proposed treatment to the insured has been provided to the insurer;
xix. communicating the deductible and co-payments were made by the insured to the service provider to the insurer;
xx. communicating annual and ever-to-date insurers report to the insured;
xxi. communicating complete medical history to the insured;
xxii. communicating the status of payment to the service provider for the proposed treatment; and
xxiii. communicating combinations thereof.

2. The smart card of claim 1, wherein the service provider information comprises a member of the group:
a. service provider code;
b. service provider name;
c. service provider address;
d. service provider phone;
e. service provider office code;
f. service provider's diagnosis;
g. service provider's treatment; and
h. service provider's prognosis..

3. The smart card of claim 1, further comprising co-insurance information selected from the group:
a. name of co-insurer;
b. policy number of co-insurer;
c. amount of funds to be paid by co-insurer; and
d. combinations thereof.

4. The smart card of claim 1 further comprising a magnetic medium on said card substrate, and wherein both of said microchip and said magnetic medium can comprise all or a portion of the information.

5. The smart card of claim 2, wherein the microchip contains medical information for executing said medical transaction.

6. The smart card of claim 3, wherein the medical information includes medicinal prescriptions.

7. The smart card of claim 1, further comprising a depiction of the owner of the smart card.

8. The smart card of claim 1, further comprising a mark of the insurer on the smart card.

9. The smart card of claim 1, further comprising a mark of the service provider on the smart card.

10. The smart card of claim 1, further comprising a mark of a third party on the smart card.

11. The smart card of claim 10, wherein the third party is a member of the group: an insurance middle middleman, a pharmacy, a medical equipment provider, a financial institution, a grocery store, a manager of a medical plan, a car rental agency, an airline, a office supply chain, a hotel chain, recreational company marks and combinations thereof.

12. The smart card of claim 1, wherein the microchip contains security information for prohibiting unauthorized access to the information contained on the smart card.

13. The smart card of claim 12, wherein the security information includes personal information in the form of a digital signature.

14. The smart card of claim 12, wherein the security information includes personal information in the form of retinal eye information.

15. The smart card of claim 12, wherein said security information includes personal information in the form of fingerprint information.

16. A magnetic readable card for accelerating the provision of funds to a service provider for medical insurance, said magnetic readable card comprising:
a. a card substrate; and
b. a magnetic medium on said card substrate, wherein said magnetic medium comprises information selected from the group:
i. insured name;
ii. insured address;
iii. insured phone;
iv. insured social security number;
v. insured fax;
vi. insured email;
vii. insurer name;
viii. insurer address;
ix. insurer phone;
x. insurer fax,
xi. insurer e-mail;
xii. insurer claims representative;
xiii. insured policy number;
xiv. insured group number;
xv. insured's co-pay amount;
xvi. insured deductible amount;
xvii. insured's medical history; and combinations thereof;
c. for communication information selected from the group: one or more of the items listed above;
i. verifying the insured is the owner of the smart card;
ii. communicating the insured's identification information to the insurer;
iii. communicating the insured's symptoms to the insurer;
iv. communicating the service provider information to the insurer;
v. transmission codes;
vi. communicating insurance coverage is current to the service provider;
vii. claim codes for an insured;
viii. deductible and co-payments required of insured;
ix. co-insurance information;
x. insured's medical history to enable a service provider to evaluate a proposed treatment;
xi. communicate the proposed treatment to an insurer;
xii. communicate the cost to be charged from the proposed treatment;
xiii. communicate from the insurer that the cost of proposed treatment fit within the guidelines of the insurer;
xiv. authorization codes to perform the proposed treatment;
xv. notice from the service provider than additional service for the insured may be needed;
xvi. eligibility of a service provider for accelerated funds transfer;
xvii. communicate that the proposed treatment to the insured has been provided to the insurer;
xviii. communicate the deductible and co-payments were made by the insured to the service provider to the insurer;
xix. communicate the status of payment to the service provider for the proposed treatment; and
xx. combinations thereof.

17. The smart card of claim 16, wherein the service provider information comprises a member of the group:
a. service provider code;
b. service provider name;
c. service provider address;
d. service provider phone; and
e. service provider office code

18. The smart card of claim 16, further comprising co insurance information selected from the group:
a. name of co-insurer;
b. policy number of co-insurer;
c. amount of funds to be paid by co-insurer; and
d. combinations thereof.

19. The smart card of claim 16, wherein said magnetic medium contains medical information for executing said medical transaction.

20. The smart card of claim 16, wherein said medical information includes medicinal prescriptions.

21. The smart card of claim 16, further comprising a depiction of the owner of the smart card.

22. The smart card of claim 16, wherein said microchip contains security information for prohibiting unauthorized access to said information contained on said smart card.

23. The smart card of claim 22, wherein said security information includes personal information in the form of a digital signature.

24. The smart card of claim 22, wherein said security information includes personal information in the form of retinal eye information.

25. The smart card of claim 22, wherein said security information includes personal information in the form comprising biometrics information.

26. The smart card of claim 25, wherein the biometrics information is fingerprint information.
